(19) United States
(12) Patent Application Publication
(10) Pub. No.: US 2017/0021972 A1
(43) Pub. Date: Jan. 26, 2017

(54) POLYMER FILMS

(71) Applicant: IRPLAST S.p.A., Empoli (IT)

(72) Inventors: Carmelo DI COSTANZO, Lanciano, Chieti (IT); Angelo MONTAGANO, Vasto, Chieti (IT); Michael PIERSE, Novi Ligure, Alessandria (IT); Roberto TROILO, Chieti (IT)

(21) Appl. No.: 15/217,150

(22) Filed: Jul. 22, 2016

(30) Foreign Application Priority Data
Jul. 23, 2015 (IT) 102015000037710

(51) Int. Cl. B65D 27/04; B32B 27/32; B32B 27/08

(52) U.S. Cl. CPC B65D 27/04; B32B 27/08; B32B 27/32; B32B 2553/00; B32B 2307/412; B32B 2307/408

(57) ABSTRACT

Multi-layer polyolefin films for envelope windows, comprising at least three layers wherein the central layer comprises a propylene homopolymer; the layer of film on the outer part of the envelope, which forms the anti-reflective layer, is based on propylene copolymers in mixture with HDPE, HDPE being comprised between 40 and 50% by weight of the mixture; the inner layer in contact with the contents of the envelope is based on ethylene/propylene/butene copolymers, the film being isotropic in relation to shear strength.

The present invention relates to polyolefin films for making anti-reflective transparent windows for envelopes, postal products, etc.

More particularly, the present invention relates to multi-layer polypropylene-based films for making anti-reflective transparent windows for envelopes, postal products, etc. characterised in that it has a percentage of production waste lower than 0.002%, preferably lower than 0.001%.

Polymeric films used for this application are known wherein the polymeric film is based on polystyrene. See, for example, patent EP2832541. The drawback of these films is that they do not allow a high number of windows for envelopes to be obtained per unit of polymer weight.

In the art polymeric films are also known based on polyolefins which overcome this drawback and allow a higher number of windows for envelopes to be obtained per quantity of polymer used. See, for example, the patent indicated above. The disadvantage of using polyolefin films for this application lies in the fact that the percentage of processing waste is quite high, in the order of 100 to 300 envelopes/day using an applicator that operates at about 1200 envelopes/minute, since when the polymeric film window is cut it does not produce envelopes that are acceptable on the market.

To overcome this drawback, patent DE 10 2007 048 090 A1 is known, wherein the thickness of the film is less than or equal to 25 μm in order to be able to substantially eliminate the wastes. Comparative examples show that if this thickness is exceeded, the processing waste levels often become significant. A need was felt for the availability of multi-layer polymeric films based on polyolefins to be used for transparent envelope windows, which led to a substantial reduction or even elimination of waste during the application step, so as to have envelopes that are acceptable on the market.

The Applicant unexpectedly and surprisingly found the solution to this technical problem using films such as those defined below.

An object of the present invention is multi-layer polyolefin films for envelope windows comprising at least three layers wherein:
the central layer (core) comprises one or more polypropylene homopolymers;
the outer layer of the film on the outer part of the envelope (visible), which forms the anti-reflective layer, is based on copolymers of propylene in a mixture with HDPE, HDPE being between 40 and 50% by weight of the mixture;
the inner layer, in contact with the contents of the envelope is based on propylene copolymers;
   the film is isotropic in relation to shear strength (tear resistance).

In practice, the tear resistance in MD direction and in TD direction and the ratio between these two values (tear resistance in MD/tear resistance in TD) is calculated, which must be comprised between 0.85 and 1.20, preferably between 0.95 and 1.15.

The multi-layer films according to the present invention are thermoplastic.

The HDPE comprised between 40 and 50% by weight in the outer layer of the film has a matting effect.

The film according to the present invention may even have a number of layers higher than three, generally 5 or 7 layers etc., wherein the central layer comprises one or more propylene homopolymers in which the quantity of extractables in n-hexane (50° C. for two hours) is less than 10%, preferably less than 5%, even more preferably less than 2% by weight, as determined according to standard FDA 177 1520.

Preferably the copolymers of the outer layer are based on propylene with at least another comonomer containing at least one ethylenic unsaturation chosen among ethylene, alpha-olefins, linear or branched when possible, having a number of carbon atoms from 4 to 12, the total quantity of comonomers being comprised between 0.5 and 25% by weight, preferably from 1 to 10% by weight out of the total monomers. The comonomers containing at least one ethylenic unsaturation are for example ethylene, butene, hexene, octene, decene and dodecene. Preferably the comonomer is ethylene.

In general the copolymers contain (% by weight) ethylene <10% preferably 1-8%. The monomer alpha-olefin (% by weight) is comprised between 0 and 10%, preferably 0.5-6%.

Examples of propylene-based copolymers are propylene/ethylene, propylene/ethylene/butene, propylene/butene/ethylene, etc.

The preferred copolymer is the propylene/ethylene copolymer <8%.

The inner layer comprises polypropylene-based copolymers with one or more monomers chosen from ethylene, alpha-olefins, linear or branched when possible, having in the chain a number of carbon atoms ranging from 4 to 12. The quantity of ethylene and alpha-olefins is less than 20%, preferably less than 10% by weight out of the total polymer.

In a preferred embodiment a propylene/ethylene/butene terpolymer is used.

Further comonomers (% in moles) that may be present in the copolymers are cyclopentadiene and terpenes, in molar quantities up to 10%, preferably 0-5%.

Propylene copolymers have a quantity of extractables less than 10% by weight, preferably less than 3%.

The melt flow index of propylene copolymers is preferably comprised between 1 and 30 g/10 min (230° C. 10 min load 2.16 kg ASTM D1238).

In a preferred embodiment the film according to the invention is formed by a core of propylene homopolymer, an outer layer formed by a propylene/ethylene copolymer in which ethylene <8% by weight, the complement to 100 being comprised of propylene; an inner layer comprised of a propylene/ethylene/butene terpolymer wherein the quantity of ethylene+butene is less than 10% by weight, the complement to 100 being comprised of propylene.

The outer layer of the film according to the present invention is spread with a glue onto the part in contact with the paper to enable the adhesion of the film to the envelope.

Examples of glues are products on the market called Eukalin 6415 EF, Fuller Swift-Tak 1304, etc.

Both in the inner and in the outer layer of the film, there may be optional components chosen from slip agents and anti-blocking agents; the core may optionally contain anti-static agents and/or polyolefin copolymers etc. The optional components in the inner and outer layer are added by taking away an equal amount of copolymer, whereas in the core an equal amount of homopolymer is taken away.

Generally, the optional components are added in the form of masterbatches wherein the carrier comprises an olefin polymer and the quantity of optional agent is comprised between 1,000 and 5,000 ppm with respect to the total weight of the layer.

Slip agents may be higher aliphatic acid amides, higher aliphatic acid esters, waxes, salts of fatty acids with metals and polydimethylsiloxanes. The quantity is that generally used in films.

Anti-blocking agents may be inorganic compounds such as, for example, silicon dioxide. The quantity is generally comprised between 1,000 and 2,000 ppm with respect to the weight of the layer.

Anti-static agents may be glycerol monostearate, aliphatic tertiary amines with saturated linear chains containing a C₁₀-C₂₀ aliphatic radical and substituted with ω-hydroxy-(C₁-C₄) alkyl groups. Tertiary amines may be N,N-bis(2-hydroxyethyl)alkylamine containing C₁₀-C₂₀ alkyl groups, preferably C₁₂-C₁₈. The quantity of anti-static agent is generally comprised between 1,000 and 2,000 ppm with respect to the weight of the layer.

In the film according to the present invention, preferably in the core, propylene-based olefin copolymers may also be added, for example as indicated above, preferably in a quantity of 10 to 20% by weight, reducing the quantity of homopolymer accordingly. As an alternative, ethylene copolymers may be used with one or more linear or branched alpha-olefins with 3 to 20 carbon atoms, optionally in presence of other comonomers containing more than one double bond in addition to the alpha-olefin bond, conjugated or not, with 4 to 20 carbon atoms or cyclic wherein the ring has 5 or 6 carbon atoms, preferably cycloalkenes, such as vinylcyclohexene, aromatics such as cyclopentadiene. The alpha-olefin and diene monomers may also be chosen from those indicated above, including propylene. The total quantity of comonomers (% in moles) in ethylene copolymers is comprised between 5 and 50%, preferably between 10 and 25%, the number average molecular weight preferably being comprised between 300 and 25,000. The quantity of copolymers (% by weight) in the core preferably varies between 0 and 20% with respect to the quantity of propylene homopolymers of the film or the core, even more preferably between 0 and 3%.

The film according to the present invention is preferably bioriented. Shear strength isotropic film means that the shear strength (tear resistance) in the MD and in the TD direction is substantially equal.

To obtain shear strength isotropic film according to the present invention, the stretch ratio values in MD (machine direction) are comprised between 5.9 and 8 and in TD (transversal direction) between 5.5 and 8 and such that the following relationship (a) is satisfied:

|(ratio(MD)−ratio(TD)|/(̂(ratio(MD), ratio(TD))<13%

i.e. inequality requires the absolute value of the difference between the stretch ratio in MD and the stretch ratio in TD, divided by the minimum value between the stretch ratio in MD and that in TD to be less than 13%. According to the present invention this definition leads to substantially isotropic film with respect to tear resistance.

This relationship is valid for simultaneous stretching in MD and in TD using a simultaneous stretching machine, preferably the LISIM®.

It is to be noted that this relationship is not valid when sequential stretching is used, i.e. the film is stretched first in MD and then in TD. In fact, in this case, stretching in TD changes the orientation of the polymeric molecules obtained in the first step of sequential stretching in MD.

The films according to the present invention are preferably obtainable by extrusion of polyolefin polymer granules, since the films are wrapped in rolls having very high lengths, even in the order of 20,000 metres. These rolls are commonly known as extruded mother rolls. From these, in a subsequent cutting step, the rolls are obtained to be used to form the windows in the application step to the envelopes, having a width of 120 mm and cut to a length of 65 mm.

The thickness of the multi-layer film is generally comprised between 15 and 40 μm, preferably >25.5 μm up to 35 μm, more preferably 28-33 μm. The thickness of the central layer varies between 12 and 38 μm.

The thickness of the inner layer and the outer layer varies in the range between 0.3-4 μm, preferably 0.5-2.5 μm. The thickness of the inner layer may be the same or different from the thickness of the outer layer.

The films according to the invention may be obtained using simultaneous stretching technology. LISIM® technology is described in various patents. See, for example, U.S. Pat. No. 4,853,602 and U.S. Pat. No. 5,051,225.

The process for obtaining the multi-layer films according to the invention comprises the following steps:
coextrusion of a multi-layer sheet of the film according to the invention, i.e. of a multi-layer sheet comprising the same layers of the film according to the invention, having a thickness preferably comprised between about 0.5 mm and about 4 mm;
cooling of the sheet on the surface of a cooled chill roll and immersed in a water bath preferably at a temperature comprised between 5 and 35° C.
heating of the sheet preferably using infrared radiation units wherein the surface of the IR panels has a temperature comprised between about 100° C. and about 500° C.;
stretching and orientation of the sheet and obtaining the multi-layer film with a simultaneous orientation process by gripping the edges of the sheet, which have a higher thickness than the sheet, with a series of grippers/clamps independently guided by linear synchronous induction motors, wherein the assembly of grippers/clamps slides on diverging stretching tracks;
the linear synchronous induction motors are powered with alternating currents whose phases and frequencies are modulated so that the grippers/clamps follow a pre-programmed linear speed to obtain the required stretch ratios in MD;
wherein the MD stretch ratios are a function of the longitudinal linear speed profile and the TD stretch ratios are regulated by the distance (divergence) between the stretching rails;
the stretching frame used for the film stretching steps comprises one or more sections which are located inside an oven having a temperature comprised between about 150° C. and 190° C.;
the longitudinal stretch ratios MD being comprised between 5.9 and 8 and in TD between 5.5 and 8, operating so that the inequality (a) is satisfied,
final heat setting in TD performed using convergence of the stretching tracks in one or more sections of the
stretching frame at temperatures of about 130° C.-140° C. and heat setting in MD obtained by reducing the linear speed of the grippers.

As a first approximation, the stretch ratio in MD can be considered equal to the ratio between the outlet speed of the film from the stretching frame and the inlet speed of the film into the stretching frame. In relation to the set-up of the stretching equipment, this ratio is equivalent to the ratio between the frequency of the alternating current supplied to the linear electric motors at the outlet of the stretching frame and the frequency of the alternating current supplied to the linear motors at the inlet of the stretching frame.

The stretch ratio in TD can be considered as a first approximation equivalent to the ratio between the width of the film at the outlet of the stretching frame and the width of the film at the inlet of the stretching frame.

The outer layer, and optionally also the inner layer, is subjected to surface treatments in order to facilitate good anchoring of the glue to the film.

The surface treatment may be corona, flame or plasma type. As mentioned, the films according to the invention enable a somewhat higher number of windows to be obtained for envelopes than polystyrene polymers per unit of polymer weight. This leads to the use of lower quantities of plastic materials, reducing on one hand the energy consumption required for their production and, on the other hand, reducing the amount of CO₂ produced and therefore lower global warming potential (GWP).

Polymerization for obtaining (co)polymers can be performed by operating with the suspension technique, in an inert diluent, in emulsion or in gaseous phase, with temperatures generally in the range from 0° C. to 150° C. at pressures generally in the range from 1 to 300 bar, optionally using a molecular weight regulator, for example, hydrogen. Polymerization using metallocenes may be carried out using catalysts comprising the reaction product of:
1) a bis-cyclopentadienyl derivative containing groups with oxygen linked to the transition metal, chosen from group IIIb to group Vb or the series of lanthanides from the periodic table of the elements;
2) a cocatalyst chosen from alumoxanes.

Polymerisation technology with metallocenes is well known in the art and should be referred to for the operational details.

A further object of the invention comprises the use of the films according to the invention for obtaining anti-reflective transparent windows for envelopes, postal products, etc. with a percentage of production waste lower than 0.002%, preferably lower than 0.001%, using applicators having an application speed between 1,000 and 1,300 envelopes/minute. The practical result obtained with the film according to the invention shows that with an applicator that produces 1,200 envelopes/minute, the waste is lower than 12 envelopes in 8 operating hours. Therefore, in a 24-hour production cycle, the waste is lower than 36 envelopes.

In the process according to the present invention, the waste is preferably lower than 6 envelopes in 8 hours and 18 envelopes in 24 hours.

The Applicant has unexpectedly and surprisingly found that operating with these films, according to the Applicant's non-binding interpretation of the present invention, there are no preferential directions in which the cut can be made, and in this way there is substantially no waste.

Applicators do not require any modifications for the use of the films according to the present invention with respect to the films currently used on the market.

As mentioned, this leads to notable advantages from an industrial point of view in relation to sustainability since waste disposal is notably reduced with respect to the polyolefin films described for this application in the known art.

A further object of the present invention also relates to envelopes provided with anti-reflective transparent windows, wherein said windows are produced with the films according to the present invention.

The following examples are provided for illustrative and non-limiting purposes of the present invention.

### EXAMPLES

Tear Resistance

The determination is performed with an Elmendorf pendulum according to ASTM D 1424.

Melting Point of the Polymers

The melting point was determined using DSC.

Heat Shrinkage of the Film

The heat shrinkage of the film is determined according to standard OPMA TC 4 by heating the sample having dimensions 20 cm×1 cm at 130° C. for 5 minutes in air.

The heat shrinkage in MD or TD is calculated with the following formula:

$$\frac{( L 1 - L 2 ) \times 100}{L 1}$$

wherein:

L1 is the length of the film prior to the heat treatment;

L2 is the length of the film after the heat treatment.

The heat shrinkage can also be indicated with the number obtained in the previous equation preceded by the negative sign (−).

Extractables in n-hexane

Determined according to standard FDA 177-1520.

Melt Flow Index

The determination is performed according to ASTM D1238, at 230° C. for 10 min with a load of 2.16 kg both in MD and TD direction.

### Example 1

A 3-layer film was prepared by extrusion composed as follows:
inner layer corresponding to the “glossy layer” in contact with the contents of the envelope, with a thickness of 0.7 μm, consisting of (% by weight):
95% terpolymer 03/02/04 LyondelBasell®: Adsy15C30F®, wherein the total quantity of C2 and C4 is less than 20% by weight;
5% slip agent masterbatch CONSTAB® SAAB 6552.
outer layer, corresponding to the “matt layer” i.e. the visible side of the envelope window having a thickness of 1.7 μm, consisting of (% by weight):
98% matting agent masterbatch Ampacet® Matif 400219 (matt) formed by a mixture of a 03/02/04 propylene copolymer as described for the inner layer with HDPE 40% by weight out of the mixture,
2% slip agent masterbatch CONSTAB® AB6084, wherein the masterbatch polymer is a propylene homopolymer,
central layer having a thickness of 20.7 μm, consisting of (% by weight):
88.45% homopolymer PP LyondelBasell® HP520H,
1.55% anti-static agent masterbatch Ampacet® wherein the polymer is a propylene (co)polymer,
10% PP reclaim,

The total thickness of the film is 23.1 μm.

The total hourly capacity of the three extruders is 1998 kg/h.

The production speed of the film is 250 m/min.

The film was obtained using a flat-die simultaneous biaxial Filming process, which consists of the following steps:
extrusion of a three-layer sheet,
cooling and tempering of the sheet,
pre-heating in an IR battery,
stretching in a LISIM® simultaneous stretching oven,
corona treatment,
winding the film onto the mother roll, which is then cut into the final rolls which have the dimensions required by the application.

The details of the individual steps are reported below.

Extrusion of a Three-Layer Sheet

The inner layer was produced with a single screw extruder whose operating conditions are as follows:

capacity: 61.4 kg/h,

temperature of the screw feeding zone: 50° C.,

temperature range: 235° C.-250° C.,

temperature of the filtration and transport line of the melt to the die: 255° C.,

screw rotation speed: 9 rpm.

The outer layer was produced with a single screw extruder whose operating conditions are as follows:

capacity: 145.4 kg/h

screw feeding zone: 50° C.,

temperature range: 275° C.-285° C.,

temperature of the filtration and transport line of the melt to the die: 290° C.,

screw rotation speed: 21 rpm.

The central layer was produced with a double screw extruder equipped with a gear pump for the melt whose operating conditions are as follows:

total capacity: 2,168 kg/h,

incoming granule flow rate (excluding recycled material): 1,791 kg/h,

extruder temperature range: 240° C.-260° C.,

temperature of the melt pump: 255° C.,

temperature of the filtration and transport line of the melt: 250° C. before the

filter, 257° C. on the filter, 252° C.-237° C. after the filter,

rotation speed of the double screw extruder=145 rpm,

pump rotation speed=35 rpm.

The three independent polymer flows were superimposed in a flat die at T=250° C., so as to obtain a three-layer coextruded film.

Cooling and Tempering

After extrusion through the flat die, the three-layer film was cooled and solidified on a roller provided with a gap in which water flows at the temperature of 30° C., rotating at the linear speed of 40 m/min, and immersed in a bath in which water circulates at the temperature of 30° C. The solidified film is known as “cast” film.

Preheating with IR

The cast film, at the speed of 40 m/min, was heated in a battery of IR panels whose temperature range is 220-350° C.

Filming in a LISIM® Simultaneous Stretching Oven.

The cast film preheated with IR was stretched in a LISIM® simultaneous stretching oven, with the following process conditions:

stretch ratio in MD: 6.20.

stretch ratio in TD: 6.86.

Under these conditions value (a) equals 10.6.

Temperature profile in the preheating zone: 170° C.-173° C.-171° C.

Temperature in the biaxial stretching zone: 158° C.

Temperature profile in the annealing zone: 160° C.-166° C.-164° C.

Corona Treatment and Winding the Film onto the Mother Roll

At the oven outlet the film was subjected to a corona treatment on the matt side, so as to obtain a surface energy value of 54 dyne/cm.

It was then wound onto the mother roll.

The film obtained is an isotropic film as shown by the shear strength (tear resistance) that has substantially the same value both in the MD and the TD direction.

The tear resistance in MD is 5 cN, in TD it is 4.4 cN and their ratio is 1.14.

### Example 2

A 3-layer film was prepared by extrusion composed as follows:

The inner and outer layer have the same composition as the corresponding values of the film in Example 1.

The central layer has the same film composition as the film in Example 1 but the thickness is 23.36 μm.

The total thickness of the film is 25.76 μm.

The total hourly capacity of the three extruders is 2,211 kg/h.

The production speed of the film is 250 m/min.

The film was obtained using a simultaneous biaxial film stretching process with a flat die, which consists of the following steps:
extrusion of a three-layer sheet,
cooling and tempering of the sheet,
pre-heating in an IR battery,
stretching in a LISIM® simultaneous stretching oven,
corona treatment,
winding the film onto the mother roll, which is then cut into the final rolls which have the dimensions required by the application.

The details of the individual steps are reported below.

Extrusion of a Three-Layer Sheet

The inner layer was produced with a single screw extruder whose operating conditions are as follows:

capacity: 61.4 kg/h,

temperature of the screw feeding zone: 50° C.,

temperature range: 235° C.-250° C.,

temperature of the filtration and transport line of the melt to the die: 255° C.,

screw rotation speed: 9 rpm.

The outer layer was produced with a single screw extruder whose operating conditions are as follows:

capacity: 145.4 kg/h

screw feeding zone: 50° C.,

temperature range: 275° C.-285° C.,

temperature of the filtration and transport line of the melt to the die: 290° C.,

screw rotation speed: 22 rpm.

The central layer was produced with a double screw extruder equipped with a gear pump for the melt whose operating conditions are:

total capacity: 2,211 kg/h,

incoming granule flow rate: 2,004 kg/h,

extruder temperature range: 240° C.-260° C.,

temperature of the melt pump: 255° C.,

temperature of the filtration and transport line of the melt:

250° C. before the filter, 257° C. on the filter, 252° C.-237° C. after the filter,

double screw rotation speed: 163 rpm,

pump rotation speed: 39 rpm.

The three independent polymer flows were superimposed in a flat die at T=250° C., so as to obtain a three-layer coextruded film.

Cooling and tempering

After extrusion through the flat die, the three-layer film was cooled and solidified on a roller provided with a gap in which water flows at the temperature of 30° C., rotating at the linear speed of 40 m/min, and immersed in a bath in which water circulates at the temperature of 30° C.

Preheating with IR

The film at the speed of 40 m/min was heated in a battery of IR panels whose temperature range is 240-370° C.

Filming in a LISIM® Simultaneous Stretching Oven

The cast preheated with IR was coated in a LISIM® simultaneous stretching oven, with the following process conditions:

stretch ratio in MD: 6.20.

stretch ratio in TD: 6.86.

Under these conditions value (a) is 10.6.

Temperature profile in the preheating zone: 173° C.-176° C.-174° C.

Temperature set of the biaxial stretching zone: 159° C.

Temperature profile of the annealing zone: 161° C.-167° C.-165° C.

Corona Treatment and Winding Onto the Mother Roll

At the oven outlet the film was subjected to a corona treatment on the outer layer, so as to obtain a surface energy value of 54 dyne/cm.

The film was then wound onto the mother roll.

The film is isotropic as shown by the shear strength that has substantially the same value both in the MD and the TD direction.

The tear resistance in MD is 5.7 cN, in TD it is 5.3 cN and their ratio is 1.08.

### Example 3

### Comparative

Example 1 was repeated but the film has a thickness of 35 micron and was prepared using a sequential stretching machine with a stretching ratio in MD of 5.0 and in TD of 7.5.

Under these conditions value (a) is 40%.

The film obtained is not an isotropic film as shown by the shear strength that has a lower value in the MD direction than in the TD direction.

The tear resistance in MD is 10 cN, in TD it is 6.6 cN and their ratio is 1.52 which indicates that the film is not isotropic in relation to tear resistance.

### Example 4

### Application

The rolls used have a width of 120 mm and were cut during application to a length of 120 mm.

The film of Example 1 was used on a Winker-Dunnebier AG 102 RE machine which produces windows for envelopes in which the visible part of the window has the dimensions 100×45 mm and the window has total dimensions 120×65 mm, the matt side being fixed to the envelopes using Eukalin 6415 EF glue sold by Henkel. The machine produces 1300 envelopes/minute. In 24 hours two envelopes were rejected.

### Example 5

### Application

Example 4 Application was repeated but using the film of Example 2. The results are substantially equal to those obtained in Example 4 Application.

### Example 5

### Comparative Application

Example 4 Application is repeated but using the film of Example 3 Comparative. The results showed a clearly higher level of waste, equal to 135 envelopes in 24 hours.

1. A multi-layer polyolefin film for an envelope window, comprising at least three layers, the at least three layers including an inner layer, a central layer, and an outer layer, wherein the central layer comprises a propylene homopolymer;
the outer layer comprises a layer of film on the outer part of the envelope and is based on propylene copolymers in mixture with HDPE, HDPE comprising between 40 and 50% by weight of the mixture; and the inner layer is in contact with the contents of the envelope and is based on propylene copolymers, and wherein the multi-layer polyolefin film is isotropic in relation to shear strength.

2. The multi-layer polyolefin film according to claim 1, wherein the central layer is a propylene homopolymer containing a concentration of extractables in n-hexane at 50° C. for two hours of lower than 10%.

3. The multi-layer polyolefin film according to claim 1, wherein the propylene copolymers of the outer layer are based on polypropylene with at least one other comonomer containing at least one ethylenic unsaturation, said comonomer being selected from ethylene and alpha-olefins, the ethylene and alpha-olefins being linear or branched and having 2 carbon atoms or from 4 to 12 carbon atoms, wherein the total quantity of comonomers is between 0.5 and 25% by weight of the total monomers, and wherein the HDPE of the outer layer is a matting agent and is present in a quantity of 40-50% by weight.

4. The multi-layer polyolefin film according to claim 3, wherein the comonomer is ethylene.

5. The multi-layer polyolefin film according to claim 3, wherein the comonomer comprises ethylene and an alpha-olefin, and wherein the ethylene is present in an amount of lower than 10% by weight and the alpha-olefin monomer is in an amount of between 0 and 10% by weight.

6. The multi-layer polyolefin film according to claim 1, wherein the propylene copolymers of the inner layer comprise monomers chosen from ethylene and alpha-olefins, the ethylene and alpha-olefins being linear or branched and having a variable number of carbon atoms in a chain of from 4 to 12, and wherein the quantity of ethylene and alpha-olefin comonomers is lower than 20% by weight of the total polymer.

7. The multi-layer polyolefin film according to claim 6, wherein the propylene copolymer is a propylene/ethylene/butene terpolymer and wherein the quantity of ethylene and butene is <10%.

8. The multi-layer polyolefin film according to claim 1, wherein the inner layer and outer layer further contain slip agents, anti-blocking agents, or a combination thereof, and/or the central layer further contains anti-static agents and/or polyolefin copolymers.

9. The multi-layer polyolefin film according claim 1, wherein the central layer further comprises a propylene copolymer or an ethylene copolymer,
the propylene copolymer being based on polypropylene with at least one other comonomer containing at least one ethylenic unsaturation, said comonomer being selected from ethylene and alpha-olefins, the ethylene and alpha-olefins being linear or branched and having 2 carbon atoms or from 4 to 12 carbon atoms,
the ethylene copolymer being with one or more linear or branched alpha-olefins with 3 to 20 carbon atoms, and
wherein the central layer can optionally further comprise of other comonomers containing more than one double bond in addition to the alpha-olefin bond, conjugated or not, with 4 to 20 carbon atoms or cyclic wherein the ring has 5 or 6 carbon atoms, the total quantity of comonomers (% in moles) being between 5 and 50%, the number average molecular weight being between 300 and 25,000.

10. The multi-layer polyolefin film according to claim 9, wherein the quantity of copolymers in the central layer, in % by weight, is between 0 and 20% by weight with respect to the quantity of propylene homopolymers of the multi-layer polyolefin film or of the central layer.

11. The multi-layer polyolefin film according to claim 1, wherein the multi-layer polyolefin film is bioriented.

12. The multi-layer polyolefin film according to claim 1, wherein the thickness of the multi-layer polyolefin film is between 15 and 40 μm, the central layer has a thickness of 12-38 μm, and the inner layer and the outer layer each have a thickness in the range of 0.3-4 μm, wherein the thickness of the inner layer and the thickness of the outer layer are the same or different from each other.

13. A method of making the film according to claim 1, the method comprising the following steps:
coextruding a multi-layer sheet of the multi-layer polyolefin, the multi-layer sheet having a thickness between about 0.5 mm and about 4 mm;
cooling the multi-layer sheet on the surface of a cooled chill roll immersed in a water bath at a temperature between 5 and 35° C.;
heating the multi-layer sheet using infrared (IR) radiation units, wherein the surface of the IR units has a temperature between 100° C. and 500° C.;
stretching and orienting the multi-layer sheet, thereby obtaining the multi-layer polyolefin film with a simultaneous orientation process by gripping the edges of the multi-layer sheet, the edges of the multi-layer sheet having a higher thickness than the center of the sheet, with a series of grippers and/or clamps independently guided by linear synchronous induction motors, wherein the assembly of grippers and/or clamps slides on diverging stretching tracks;
the linear synchronous induction motors being powered with alternating currents whose phases and frequencies are modulated so that the grippers and/or clamps follow a pre-programmed linear speed to obtain the required stretch ratios in MD;
wherein the MD stretch ratios are a function of the longitudinal linear speed profile and the TD stretch ratios are regulated by the distance (divergence) between the stretching rails;
wherein the stretching frame used for the film stretching steps comprises one or more sections which are located inside an oven having a temperature between about 150° C. and 190° C.;
maintaining longitudinal stretch ratios MD between 5.9 and 8 and transversal stretching ratios TD between 5.5 and 8, operating so that

|(ratio(MD)−ratio(TD)|/(λ(ratio(MD), ratio(TD))<13%
wherein:
ratio(MD) is the stretching ratio in MD and ratio(TD) is the stretching ratio in TD,
final heat setting in TD performed using convergence of the stretching tracks in one or more sections of the stretching frame at temperatures of about 130° C.-140° C. and heat setting in MD is obtained by reducing the linear speed of the grippers.

14. A method for obtaining anti-reflective transparent windows for envelopes, postal products, or a combination thereof, the method having a percentage of application waste lower than 0.002%, the method using applicators having an application speed comprised between 1,000 and 1,300 envelopes/minute, the method comprising the use of the multi-layer polyolefin film according to claim 1.

15. Envelopes provided with anti-reflective transparent windows, wherein said windows are formed by a film according to claim 1.
